(19) United States
(12) Patent Application Publication
(10) Pub. No.: US 2022/0025972 A1
(43) Pub. Date: Jan. 27, 2022

(54) SEAL GASKET FOR FLAT PLATE STRUCTURE AND SEALING STRUCTURE THEREOF

(71) Applicant: TSINGHUA UNIVERSITY, Beijing (CN)

(72) Inventors: Rong CHENG, Beijing (CN); Yu ZHU, Beijing (CN); Kaiming YANG, Beijing (CN); Xiangbo LIU, Beijing (CN)

(21) Appl. No.: 17/311,341

(22) PCT Filed: Oct. 22, 2019
(86) PCT No.: PCT/CN2019/112593

§ 371 Date: Jun. 6, 2021

(30) Foreign Application Priority Data
Dec. 10, 2018 (CN) 201811501951.1
Dec. 10, 2018 (CN) 201822060202.1

(51) Int. Cl. F16J 15/08

(52) U.S. Cl. CPC F16J 15/0881

(57) ABSTRACT

The present disclosure relates to a sealing technology, and in particular relates to a high-vacuum or ultrahigh-vacuum seal gasket (301) for a flat plate structure and a sealing structure. The seal gasket (301) comprises a seal ring (302) and multiple metal wires (303) extending outwards from the seal ring (302). The flat plate sealing structure comprises two flat plates (401, 404), the seal gasket (301) is fixed to one flat plate (401) via the multiple extending metal wires (303) so as to accurately position the seal ring (302). Accurate positioning can be achieved by virtue of an extern force without structure improvement on flat plate workpieces, thereby ensuring that no malposition occurs after the installation of the seal gasket (301).

### FIELD OF THE INVENTION

The present disclosure relates to the filed of sealing technology, and in particular to a high-vacuum (a vacuum degree ranging from 10⁻¹ Pa to 10⁻⁶ Pa) or ultra-high-vacuum (a vacuum degree of less than 10⁻⁶ Pa) seal gasket for a flat plate structure, and a sealing structure thereof.

### BACKGROUND OF THE INVENTION

In a sealed device or a high-vacuum or ultra-high-vacuum device, it is often necessary to seal between two flat plate structures, such as the two flat-plate workpieces shown in FIG. 1. In FIG. 1, a workpiece 101 is a vacuum cavity, in which a vacuum is obtained by suction of a set of vacuum pumps. One flat-plate workpiece 102 is the workpiece 101 having a flat-plate part with an opening 104, and the other flat-plate workpiece 103 is a planar plate, or a flat plate having some structures such as an electrode, an air pipe, or a water pipe. It is necessary to connect the two flat-plate workpieces together and ensure that a high vacuum or an ultra-high vacuum can be realized in the vacuum cavity. The common sealing method using knife-edge flanges and metal gaskets is not suitable for this situation. Instead, the following sealing method is generally used: a seal gasket made of a thin metal wire as shown in FIG. 2 is clamped between the two flat-plate workpieces and positioned between the opening 104 and mounting holes 105, and the metal wire is squeezed and deformed by a pressing force between the two flat-plate workpieces to prevent the air flow thus achieving sealing. However, the seal gasket shown in FIG. 2 has some limitations. If a mounting plane of the flat-plate workpiece 102 in FIG. 1 is horizontal, it is only required to place the seal gasket shown in FIG. 2 horizontally on the mounting plane and then mount the flat-plate workpiece 103. The seal gasket will not slip and be misaligned. However, in many cases, the mounting plane of the flat-plate workpiece 102 is not horizontal, and it is likely to be inclined or vertical. In such case, it is difficult to fix the seal gasket shown in FIG. 2 in a proper position, since the seal gasket cannot be fixed by an external force. If the seal gasket is slightly misaligned and part of the gasket is not pressed, then there will be air leakage and it is impossible to obtain the ultra-high vacuum.

After searching in patent databases, it is found that the patent document CN1118419A discloses a sealing method in which stepped concave and convex structures are processed on two flat-plate workpieces, then a seal gasket is placed in the concave structure, and then the convex structure is mounted fitting with the concave structure. Although this method can achieve ultra-high-vacuum sealing between flat-plate workpieces having an inclined angle, it also has disadvantages. Firstly, stepped concave and convex structures need to be processed on the two flat-plate workpieces, which increases the processes and cost; secondly, it is not suitable for large-size seal gasket, since the diameter of the seal gasket is small and the material used is softer metal, if the size is too large, it is impossible to keep the shape by itself using its own support force; once the seal gasket is deformed, it is impossible to mount it.

### SUMMARY OF THE INVENTION

An object of the present disclosure is to provide a seal gasket that can be used in a flat plate structure having any angle. During use, the gasket can be accurately positioned by an external force without structural change for flat-plate workpiece, so that it can be ensured that the seal gasket has no misalignment after being mounted.

The present disclosure provides the following technical solution: a seal gasket including the following structures: a seal ring; and a plurality of metal wires extending outward from the seal ring.

Further, the plurality of metal wires are evenly distributed along a circumferential direction of the seal ring.

Further, the metal wires and the seal ring have the same or different materials and diameters.

Further, the seal gasket is used for sealing a high-vacuum cavity or an ultra-high-vacuum cavity.

Further, the plurality of metal wires are welded to the seal ring.

Further, the materials of the seal ring and/or the metal wires are selected from such as, gold, silver, copper, aluminum or indium.

Further, the diameters of the seal ring and/or the metal wires are 1 mm to 2 mm.

Further, the shape of the seal ring is polygonal, circular, or triangular.

The present disclosure also relates to a flat-plate sealing structure, which comprises a first flat plate and a second flat plate, wherein the first flat plate comprises an opening, a plurality of metal wires of a seal gasket are fixed on the first flat plate to position a seal ring on a sealing surface between mounting holes and the opening of the first flat plate, and the mounting holes are firmly connected to the second flat plate.

Further, the lengths of the plurality of metal wires exceed edges of the second flat plate.

The seal gasket provided by the present disclosure has the following advantages: 1) the seal gasket can be accurately positioned on a flat-plate workpiece at any angle, the implementation process is simple and fast, and the disassembly is convenient; 2) this type of seal gasket has no size and shape limitations; 3) the use of this type of seal gasket only requires fine polishing of the sealing surface, and no structural changes are required; and 4) after the seal gasket is mounted, there will be no leakage caused by misalignment, which is especially suitable for keeping the high vacuum or ultra-high vacuum.

### BRIEF DESCRIPTION OF THE DRAWINGS

FIG. 1 is a schematic view of a flat-plate sealed structure in the prior art;

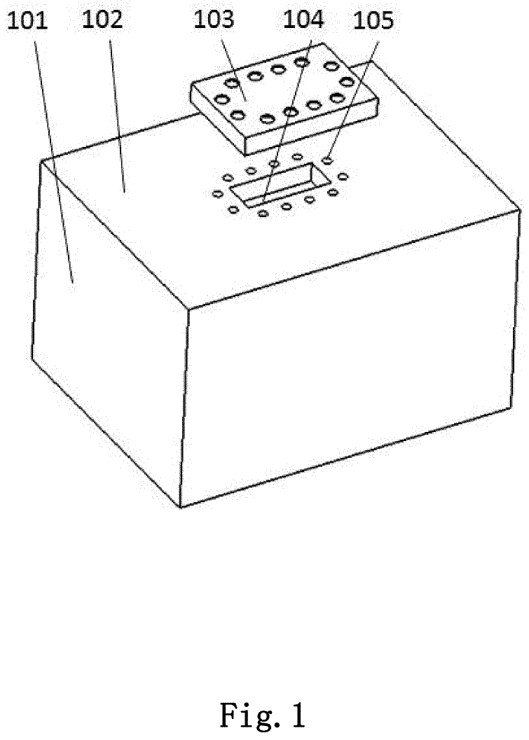

FIG. 2 is a schematic view of a seal gasket in the prior art;

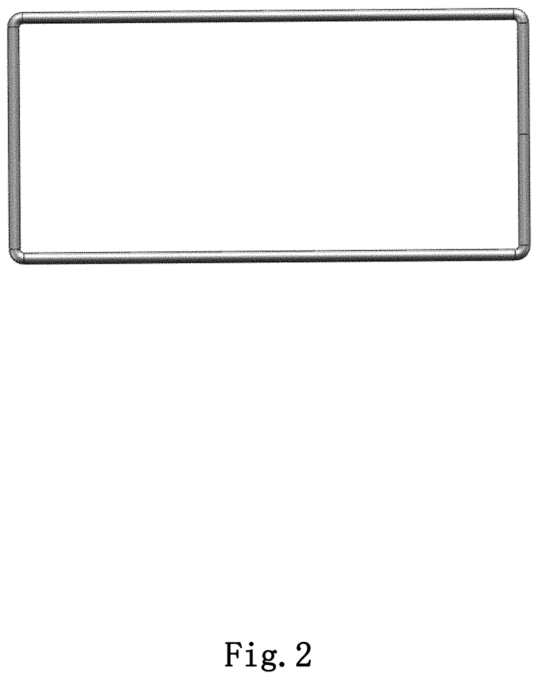

FIG. 3 is a schematic view of a seal gasket of the present disclosure;

FIG. 4 is a schematic view of the mounting of a flat-plate sealed structure of the present disclosure.

The above drawings include the following reference numbers: 101: vacuum cavity; 102: flat-plate workpiece; 103: another flat-plate workpiece; 104: opening; 105: mounting hole; 301: seal gasket; 302: seal ring; 303: extending metal wire; 401: first flat plate; 402: mounting hole; 403: opening; 404: second flat plate; 405: fastening bolt; 406: mounting surface; 407: vacuum cavity.

### DETAILED DESCRIPTION OF THE INVENTION

The technical solutions of the present disclosure will be clearly and fully described below with reference to the accompanying drawings. Obviously, the described embodiments are only some of the embodiments of the present disclosure, not all of them. Based on the embodiments of the present disclosure, all other embodiments obtained by those skilled in the art without creative work shall fall within the scope of protection of the present disclosure.

It should be noted that in the description of the present disclosure, directional or positional relationships indicated by terms such as “center”, “upper”, “lower”, “left”, “right”, “vertical”, “horizontal”, “inner” and “outer” are based on the directional or positional relationships shown in the drawings. They are merely used for the convenience of simplified description of the present disclosure, and do not indicate or imply that the device or element involved must have a specific orientation, or be configured or operated in a specific orientation. Therefore, they should not be construed as limiting the present disclosure. In addition, terms “first”, “second” and “third” are used for descriptive purpose only, and should not be construed as indicating or implying relative importance.

It should be noted that in the description of the present disclosure, unless otherwise clearly specified and defined, terms “mount”, “connect” and “fix” should be understood in a broad sense; for example, the connection may be a fixed connection, or may also be a detachable connection, or an integral connection; it may be a mechanical connection, or may also be an electrical connection; it may be a direct connection, or an indirect connection implemented through an intermediate medium, or it may be an internal connectivity between two elements. For those skilled in the art, the specific meaning of the above terms in the present disclosure can be understood according to specific situations.

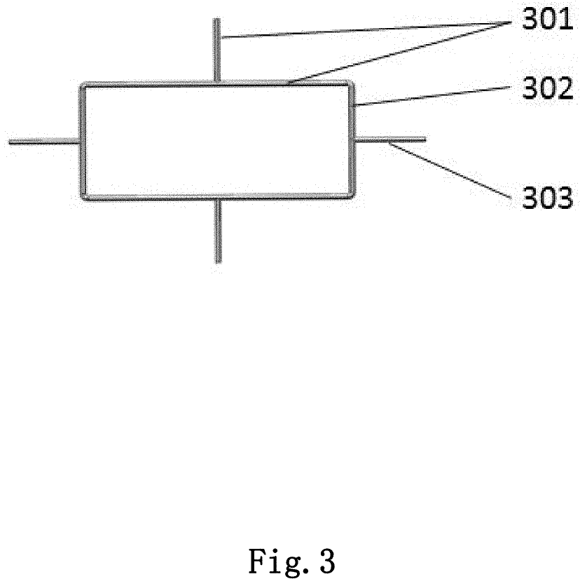

As shown in FIG. 3, a metal seal gasket 301 provided by the present disclosure may be formed by welding thin metal wires preferably made of gold, silver, copper, aluminum or indium, and the diameters of the metal wires are preferably 1 mm to 2 mm. First, the metal wires are welded to form a seal ring 302 according to the desired shape and size, and the seal ring 302 may be of any shape, such as polygonal, circular, or triangular, etc. There should be no obvious protrusions at welded joints, or the welded joints are trimmed with a tool such as a file after welding, so that there are no obvious protrusions. Then according to the actual working conditions, a plurality of outward extending metal wires 303 are welded at appropriate positions on the metal ring. The plurality of metal wires are reasonably distributed along a circumferential direction, preferably evenly distributed along the circumferential direction. The plurality of metal wires and the metal wires used for the seal ring may be of the same material or different materials, preferably the same for facilitating welding, and it is also required that the welded joints have no obvious protrusions. The above welding method may also be replaced by other connection methods, such as bonding, crimping, etc.

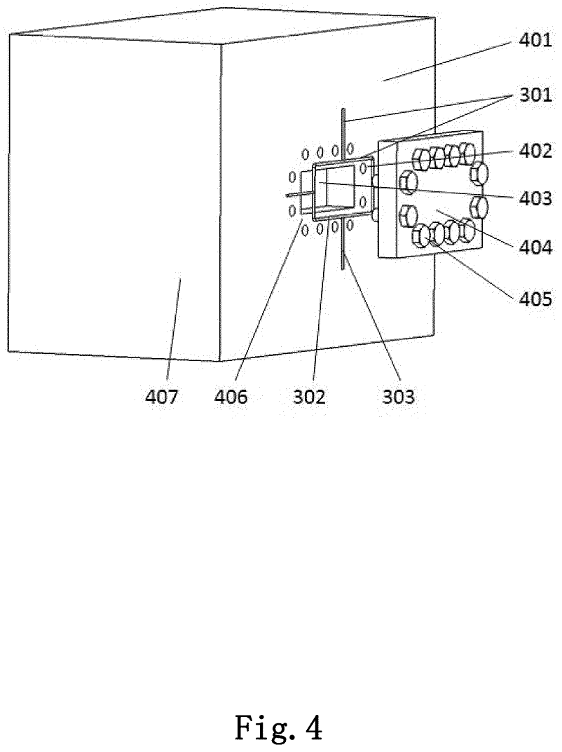

FIG. 4 is a schematic view of the mounting of a flat-plate sealed structure of the present disclosure.

A first flat plate 401 is a flat plate on a vacuum cavity 407 and is provided with an opening 403. The opening 403 may be of any shape, preferably circular or square. A second flat plate 404 needs to be mounted on the first flat plate 401, and the connection part has to meet sealing requirements of sealing cavity or high-vacuum or ultra-high-vacuum. The specific implementation process is described as follows: the metal seal gasket 301 is placed at a proper position on a surface of the first flat plate 401, and it is required to position the seal ring 302 of the seal gasket 301 on a sealing surface 406 between mounting holes 402 (preferably threaded holes) and the opening 403. The sealing surface 406 and a sealing surface of the second flat plate 404 that needs to press against the seal ring are preferably fine polished to reach a roughness Ra of less than 0.05 μm. After the position of the seal ring 302 is selected, the plurality of outward extending welded metal wires 303 on the seal gasket 301 are respectively fixed on the sealing surface by way of bonding, pressing, etc. The lengths of the plurality of metal wires 303 preferably exceed edges of the second flat plate 404. Since the plurality of outward extending metal wires 303 on the seal gasket 301 are fixed on the surface of the first flat plate 401, the seal gasket is prevented from slipping off or being misaligned. Then, the second flat plate 404 is mounted on the first flat plate 401 with fastening bolts 405 or other connectors, and the seal ring 302 is squeezed and deformed by the two flat-plate workpieces through the tightening and pressing forces of the bolts or other connectors, thus achieving sealing.

The embodiments described above are preferred embodiments of the present disclosure, but the embodiments of the present disclosure are not limited by the embodiments described above, and any other changes, modifications, substitutions, combinations and simplifications made without departing from the spirit and principle of the present disclosure should all be taken as equivalent replacements, which are all included within the scope of protection of the present disclosure.

What is claimed is:

1. A seal gasket (301), comprising the following structures:
a seal ring (302); and
a plurality of metal wires (303) extending outward from the seal ring.

2. The seal gasket according to claim 1, wherein the plurality of metal wires are evenly distributed along a circumferential direction of the seal ring.

3. The seal gasket according to claim 1, wherein the materials and diameters of the plurality of metal wires and the seal ring are the same or different.

4. The seal gasket according to claim 1, wherein the seal gasket is used for sealing a high-vacuum cavity or an ultra-high-vacuum cavity.

5. The seal gasket according to claim 1, wherein the plurality of metal wires are welded to the seal ring.

6. The seal gasket according to claim 2, wherein the plurality of metal wires are welded to the seal ring.

7. The seal gasket according to claim 3, wherein the plurality of metal wires are welded to the seal ring.

8. The seal gasket according to claim 4, wherein the plurality of metal wires are welded to the seal ring.

9. The seal gasket according to claim 1, wherein the materials of the seal ring and/or the metal wires are selected from gold, silver, copper, aluminum or indium.

10. The seal gasket according to claim 2, wherein the materials of the seal ring and/or the metal wires are selected from gold, silver, copper, aluminum or indium.

11. The seal gasket according to claim 3, wherein the materials of the seal ring and/or the metal wires are selected from gold, silver, copper, aluminum or indium.

12. The seal gasket according to claim 4, wherein the materials of the seal ring and/or the metal wires are selected from gold, silver, copper, aluminum or indium.

13. The seal gasket according to claim 1, wherein the diameters of the seal ring and/or the metal wires are 1 mm to 2 mm.

14. The seal gasket according to claim 2, wherein the diameters of the seal ring and/or the metal wires are 1 mm to 2 mm.

15. The seal gasket according to claim 3, wherein the diameters of the seal ring and/or the metal wires are 1 mm to 2 mm.

16. The seal gasket according to claim 4, wherein the diameters of the seal ring and/or the metal wires are 1 mm to 2 mm.

17. The seal gasket according to claim 1, wherein the shape of the seal ring is polygonal, circular, or triangular.

18. The seal gasket according to claim 2, wherein the shape of the seal ring is polygonal, circular, or triangular.

19. A flat-plate sealed structure, comprising a first flat plate (401) and a second flat plate (404), and the first flat plate (401) comprising an opening (403), wherein the flat-plate sealed structure further comprises the seal gasket (301) according to any one of claims 1 to 8, the plurality of metal wires (303) of the seal gasket (301) are fixed on the first flat plate (401) to position the seal ring (302) on a sealing surface between mounting holes (402) of the first flat plate (401) and the opening (403) of the first flat plate (401), and the mounting holes (402) are firmly connected to the second flat plate (404).

20. The flat-plate sealed structure according to claim 9, wherein the lengths of the plurality of metal wires exceed edges of the second flat plate (404).
